(19) United States
(12) Patent Application Publication
(10) Pub. No.: US 2026/0316632 A1
(43) Pub. Date: Oct. 15, 2026

(54) DRIVE DEVICE WITH A PREDETERMINED BREAKING ELEMENT

(71) Applicant: Brose Fahrzeugteile SE & Co. Kommanditgesellschaft, Coburg, Coburg (DE)

(72) Inventors: Jürgen SCHUKALSKI, Küps (DE); Hans-Jörg BIRKEFELD, Coburg (DE); Danny RÖCKELEIN, Schleusingen (DE)

(21) Appl. No.: 19/482,529

(22) PCT Filed: May 7, 2024
(86) PCT No.: PCT/EP2024/062528

§ 371 Date: Nov. 7, 2025

(30) Foreign Application Priority Data
May 8, 2023 (DE) 10 2023 111 913.3

(51) Int. Cl. B60N 2/02; B60N 2/16; B60N 2/427

(52) U.S. Cl. CPC B60N 2/02258; B60N 2/1615; B60N 2/164; B60N 2/42709

(57) ABSTRACT

A drive device for adjusting a vehicle seat, having a transmission with a transmission holder and a motor unit with a motor housing, which is arranged on the transmission holder and is held in an operating position (BP) relative to the transmission holder by means of a predetermined breaking element, where the motor housing can be moved out of the operating position into a deflected position relative to the transmission holder by the destruction of the predetermined breaking element.

The present invention relates to a drive device for a vehicle seat and to a corresponding vehicle seat.

Vehicle seats are typically adjustable to provide a comfortable seating position for different seat users and to accommodate different space requirements. For example, a vehicle seat can be mounted in a vehicle in a manner allowing longitudinal adjustment by means of a longitudinal adjustment device in order to allow different seating positions along the vehicle's longitudinal axis; a vehicle seat can be adjustable by means of a height adjustment device in order to adjust a seat height; and in a vehicle seat, the inclination of a backrest relative to a seat part can be adjustable, to name just a few examples. Motor drive devices may be provided to make such adjustments. This allows the settings to be made easily, e.g., by pressing buttons—or even completely automatically.

Typically, motor drive devices are mounted as firmly as possible to a component in order to be able to transmit functional forces effectively when making an adjustment. In the case of external forces, e.g., as a result of a crash or misuse, the fastening should typically be sufficiently robust or be able to absorb the forces in another way.

To account for such forces, various approaches have been proposed.

DE 198 31 442 A1 describes a transmission for seat adjustment devices in motor vehicles which, on the one hand, has an optimized efficiency and, on the other hand, ensures sufficient reliability in preventing movement of the transmission by output forces even in the case of comparatively high output forces.

US 2020/0331362 A1 describes a device for adjusting a length of a seat part of a motor vehicle seat, wherein the adjusting device comprises a threaded rod, a rotatable nut, and a housing receiving the nut and the threaded rod, wherein the nut has a nut weak point for breaking off the nut.

The object is to improve the safety of a drive device for a vehicle seat.

This object is achieved by the subject matter having the features of claim 1.

A drive device for adjusting a vehicle seat is then specified. The drive device comprises a transmission and a motor unit. The transmission has a transmission holder. The motor unit has a motor housing which is arranged on the transmission holder and is held in an operating position relative to the transmission holder by means of a predetermined breaking element. The motor housing can be moved from the operating position to a deflected position relative to the transmission holder by the destruction of the predetermined breaking element.

This is based on the realization that housings of such drive devices have not previously been sufficiently considered. If a housing of the drive device, e.g., the motor housing, breaks, an electric motor attached to it or inside it can fall off and pose an additional source of danger. By holding the motor housing in the operating position by means of the predetermined breaking element, a force can be predetermined by appropriate dimensioning of the predetermined breaking element. At any greater force, the motor housing is transferred into the deflected position. This allows the motor housing to deflect in the event of a crash, for example, while still remaining securely held to the transmission holder. This can improve the safety of the drive device. In the operating position of the motor housing, the drive device can be operated as intended.

For example, by the destruction of the predetermined breaking element, the motor housing can be pivoted from the operating position into the deflected position relative to the transmission holder. This allows the motor housing to be securely held on the transmission holder and at the same time allows for an evasive movement in the event of excessive stress.

Optionally, the motor housing can be pivoted from the operating position into the deflected position about an axis of rotation of a transmission element of the transmission relative to the transmission holder. This allows the motor housing to execute an evasive movement without causing further damage.

The transmission element may have an internal thread. The axis of rotation is aligned for example concentrically with the internal thread.

For example, the transmission element is in engagement with a spindle. This allows for precise and smooth adjustment.

It can be provided that the predetermined breaking element can be sheared off in order to allow a movement, in particular a pivoting movement of the motor housing, from the operating position into the deflected position relative to the transmission holder. In this way, the force at which the predetermined breaking element fails can be predetermined with particular precision.

For example, the predetermined breaking element is designed in the form of a shear-off lug. Such a design is particularly easy to manufacture.

In one embodiment, the motor housing forms the predetermined breaking element. This allows for easy manufacturing. Alternatively or additionally, a transmission housing that is firmly connected to the motor housing (e.g., in one piece) can form the predetermined breaking element. Alternatively, the transmission holder can form the predetermined breaking element.

Optionally, a stop is provided that is fixed to the motor housing and is designed to strike a counter stop of the transmission holder in the deflected position. In this way, the path from the operating position to the deflected position can be defined.

The motor housing can be made of plastic. The described design with the predetermined breaking element allows improved crash safety to be achieved despite the plastic housing.

The motor unit comprises, for example, an electric motor. This allows for convenient operation.

The drive device can still be adjustable even after the predetermined breaking element has been destroyed. For example, the drive device is adjustable both when the motor housing is arranged in the operating position and when it is arranged in the deflected position. For example, the electric motor can drive a transmission element of the transmission both when the motor housing is arranged in the operating position and when it is arranged in the deflected position. This ensures that functionality can still be ensured even after an overload.

According to one aspect, a vehicle seat is provided comprising the drive device according to any embodiment described herein. Regarding the advantages, reference is made to the above information on the drive device.

For example, the drive device is configured to adjust a seat height of a seat part of the vehicle seat relative to a base of the vehicle seat.

The seat part is supported on the base via a lever, for example. The drive device can be configured to exert a force on the lever and/or on the seat part in order to effect an adjustment.

Optionally, the motor unit is arranged under a seat mat of the seat part of the vehicle seat designed to support a seat cushion. In the event of a crash, this may be pressed against the motor unit, which can then move away by releasing the predetermined breaking element.

The idea underlying the invention will be explained in more detail below with reference to the embodiments shown in the figures, wherein:

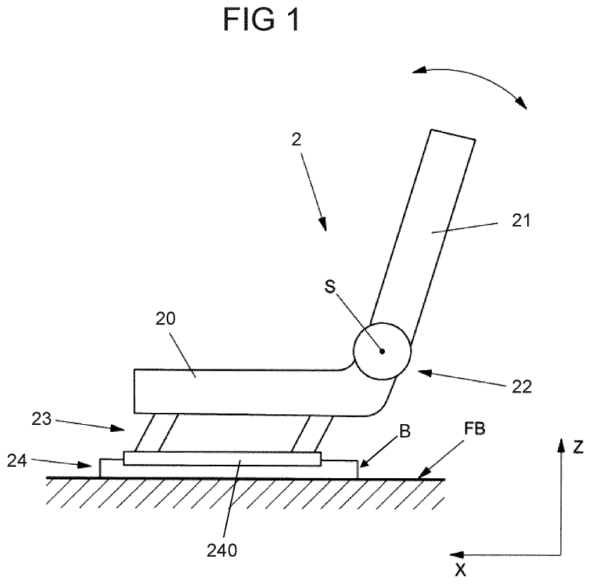

FIG. 1 shows a vehicle seat with a height adjustment device;

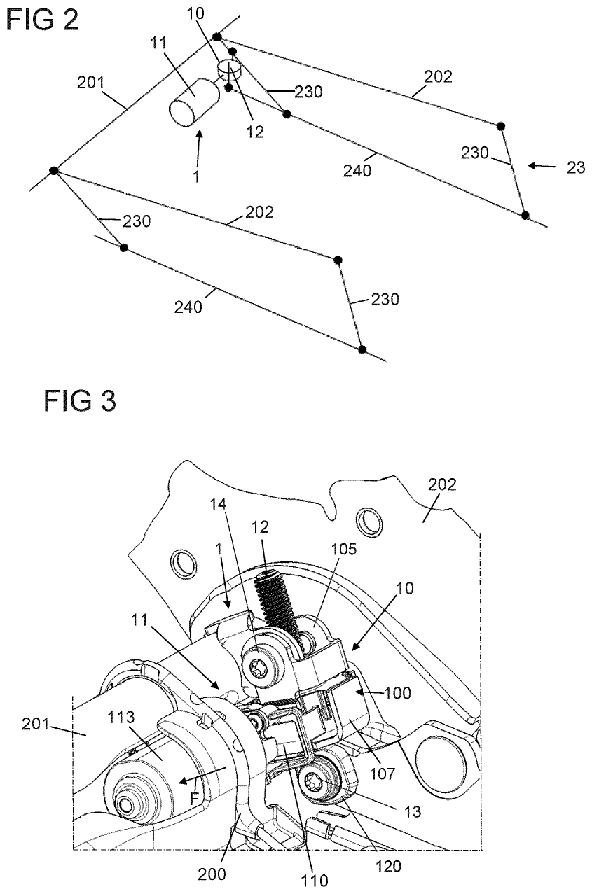

FIG. 2 is a schematic representation of the height adjustment device according to FIG. 1 and a drive device for the height adjustment device;

FIG. 3 shows the drive device mounted on the vehicle seat according to FIG. 2;

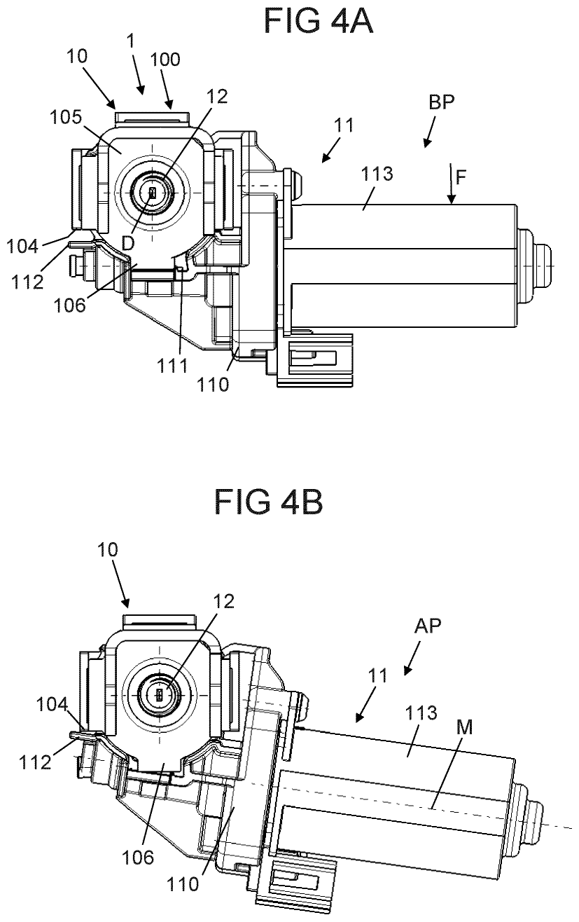

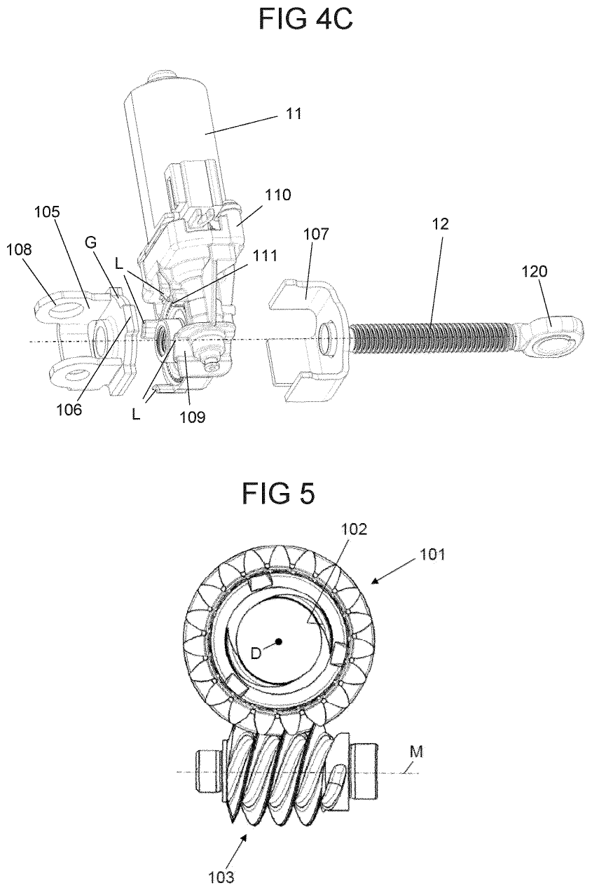

FIGS. 4A and 4B are views of the drive device according to FIG. 2 with a motor housing in an operating position and in a deflected position displaced relative to the operating position;

FIG. 4C is an exploded view of the drive device according to FIG. 2; and

FIG. 5 shows transmission elements of a transmission of the drive device according to FIG. 2.

FIG. 1 shows a vehicle seat 2 with a seat part 20 and a backrest 21. The backrest 21 is pivotably mounted on the seat part 20 about a pivot axis S by means of a fitting arrangement 22.

The seat part 20 has a seat height relative to a base B along a height axis z. The seat part 20 (together with the backrest 21) is adjustable in its seat height by means of a height adjustment device 23, as will be explained in more detail below.

The vehicle seat 2 can be mounted on a vehicle floor FB of a vehicle and is mounted as shown in FIG. 1. Furthermore, the vehicle seat 2 comprises a longitudinal adjustment device 24. The longitudinal adjustment device 24 allows a longitudinal adjustment of the vehicle seat 2 along a longitudinal axis x. By means of the longitudinal adjustment device 24, the seat part 20 and the backrest 21 can be moved together along the longitudinal axis x relative to the vehicle floor FB. The longitudinal axis x is perpendicular to the height axis z. The longitudinal adjustment device 24 comprises two pairs of rails, with one rail which can be fixed to the vehicle floor FB—which is fixed in the example shown and which can also be referred to as a floor rail—and one seat rail 240 which is mounted thereon so as to be displaceable along the longitudinal axis x. The rest of the vehicle seat 2 can be mounted on the seat rail 240, and is mounted in the example shown. The two pairs, of which only one is visible in the view of FIG. 1, are spaced apart from each other along a lateral axis. The lateral axis is aligned perpendicular to the longitudinal axis x and perpendicular to the height axis z.

In the example shown, the floor rail serves as a base B.

FIG. 2 shows the two seat rails 240 running parallel to each other, as well as two side parts 202 of the seat part 20 supported thereon via the height adjustment device 23. The side parts 202 are connected to each other via a cross tube 201, in this case fixed to each other.

The height adjustment device 23 comprises multiple levers 230, in this case two levers 230 per side part 202.

A motor drive device 1 serves to adjust the vehicle seat 2-namely in this case, for example, to adjust the seat height. For this purpose, the drive device 1 is arranged here, for example, on one of the levers 230.

The drive device 1 comprises a transmission 10 and a motor unit 11. The transmission 10 is mounted on one of the levers 230 (in the example shown on a rear lever 230). In this case, the transmission 10 is pivotably connected to the lever 230. It would also be conceivable to link the transmission 10, for example, to a side part 202 or to the cross tube 201. The transmission 10 engages with a spindle 12. The spindle 12 is pivotably mounted on the seat rail 240.

The motor unit 11 is operatively connected to the transmission 10 via a shaft. The motor unit 11 drives the transmission 10 so that the transmission 10 moves up or down on the spindle 12 depending on the direction of rotation, such that the lever 230 is pivoted and consequently the height of the seat part 20 is adjusted.

The motor unit 11 is arranged adjacent to the cross tube 201. The motor unit 11 is oriented parallel to the cross tube 201.

FIG. 3 shows the drive device 1 on the vehicle seat 2 with further details. It can be seen that the transmission 10 has a transmission holder 100 and that the motor unit 11 has a motor housing 110. The motor housing 110 is arranged on the transmission holder 100. Specifically, the motor housing 11 is attached to the transmission holder 10.

An electric motor 113 of the motor unit 11 is held on the transmission 10 by means of the motor housing 110. The electric motor 113 drives the transmission 10. The spindle 12 has a bearing point 120, in the present case in the form of an opening for receiving a bearing element 13, here in the form of a bolt. The bearing element 13 is fixed relative to the seat rail 240, in this case mounted on an adapter attached to the seat rail 240. The spindle 12 is pivotably mounted on the bearing element 13.

FIG. 3 also shows a part of a seat mat 200 of the seat part 20. The seat mat 200 is designed to support a cushion of the seat part 20. In this case, the seat mat 200 is designed to be elastically resilient. The seat mat 200 is attached at its rear end to the cross tube 201.

If strong forces act on the vehicle seat, particularly as a result of a crash, the seat mat 200, the upholstery or other parts can press against the motor unit 11, in particular against the electric motor 113. In FIG. 3, a force F which can act on the motor unit 11 is illustrated with an arrow. In this example, the force F acts diagonally backwards and downwards.

In order to absorb such a force F, the drive device 1 is designed as illustrated in FIGS. 4A and 4B. It is provided that the motor housing 110 of the motor unit 11 is held in an operating position BP relative to the transmission holder 100 by means of a predetermined breaking element 111, wherein the motor housing 110 can be moved from the operating position BP into a deflected position AP relative to the transmission holder 100 by the destruction of the predetermined breaking element 111.

FIG. 4A shows the operating position; FIG. 4B shows the deflected position AP. FIG. 4A further illustrates the force F.

From FIGS. 4A and 4B it can be seen that the predetermined breaking element 111 can be sheared off in order to allow the movement of the motor housing 110 from the operating position BP into the deflected position AP relative to the transmission holder 100. Specifically, the predetermined breaking element 111 is designed in the form of a shear-off lug.

As can be seen in particular from FIG. 4C, the motor housing 110 is fixed—in this case, integrally connected—to a transmission housing 109. The transmission housing 109 bears multiple transmission elements of the transmission 10. The shear-off lug is a part of the transmission housing 109 (but could alternatively also be designed as a part of the motor housing 110). The motor housing 110 is made of a plastic, for example PU, PA or another polymer (as is the motor housing 109). The transmission housing 109 is held by the transmission holder 100. The transmission housing 109 is arranged in the transmission holder 100.

The transmission holder 100 is made of metal, in this case of a steel sheet. It has a cage 107 which is closed by a bearing cover 105. In the present case, the bearing cover 105 is fixed to the cage 107 in the assembled state—specifically, welded to it.

The transmission holder 100 has (on the bearing cover 105) a bearing point 108 (here in the form of an opening), with which the transmission holder 100 is pivotably mounted on a bearing element 14 (here in the form of a bolt) on the lever 230 (alternatively on the seat part 20). The cage 107 and the bearing cover 105 each have an opening for the spindle 12.

In the operating position BP, the motor housing 110 is held positively on the transmission holder 100. The predetermined breaking element 111 rests on a lateral edge of a portion 106 of the transmission holder 100. The portion 106 of the transmission holder 100 is formed here on the bearing cover 105.

The shear-off lug is designed to safely transmit the functional and blocking forces that occur during operation. If the force F exceeds a predetermined magnitude, the predetermined breaking element 111 is destroyed, namely sheared off in this case, so that the motor housing 110 can be moved, namely pivoted, relative to the transmission holder 100. The motor housing 110 (with the transmission housing 109) pivots from the operating position BP into the deflected position AP about an axis of rotation D of a transmission element of the transmission 10 relative to the transmission holder 100. An additional deformation path and angle is made possible, without causing additional damage to the plastic motor housing 110 (or the transmission housing 109). This prevents, for example, the electric motor 113 from failing.

As can be seen by comparing FIGS. 4A and 4B, the axis of rotation D corresponds to the longitudinal axis of the spindle 12. The electric motor 113 has a motor axis of rotation M around which a rotor of the electric motor 113 rotates. If the motor housing 110 pivots from the operating position BP to the deflected position AP, the motor axis of rotation M is pivoted relative to the transmission holder 100. The motor axis of rotation M is aligned perpendicular to the axis of rotation D and offset from it. The drive device 1 can still be adjusted even after the predetermined breaking element 111 has been destroyed. The vehicle seat 1 can still be adjusted with the drive device 1 even after the destruction of the predetermined breaking element 111. When the motor housing 110 moves from the operating position BP to the deflected position AP, the electric motor 113 pivots about the axis of rotation D (and remains in operative connection with the spindle 12).

As can be seen in particular from FIG. 4C, the transmission housing 109 has multiple (in this case four) bearing portions L. The transmission holder 100 (more specifically: the bearing cover 105) has a plurality of sliding surfaces G, which slide on the bearing portions L when the motor housing 110 (with the transmission housing 109) pivots relative to the transmission holder 100. The bearing portions L are each designed in the form of an axially protruding projection. In the example shown, the predetermined breaking element 111 is arranged on one of the bearing portions L.

A stop 112 is also fixed to the motor housing 110. The stop 112 is designed in the form of a projection (in this case on the transmission housing 109). The transmission holder 100 has a counter stop 104. In the operating position BP, the stop 112 is spaced apart from the counter stop 104. After the destruction of the predetermined breaking element 111 and as a result of the pivoting movement of the motor housing 110 relative to the transmission holder 100, the stop 112 strikes the counter stop 104 and thus defines the deflected position AP. The stop 112 is arranged here at an end of the transmission housing 109 facing away from the electric motor 113. In this case, multiple stops and counter stops are provided.

FIG. 5 shows the already-mentioned transmission element 101 of the transmission 10, which can be rotated about the axis of rotation D. The transmission element 101 is arranged in the transmission holder 100. The transmission element 101 is designed in the form of a spindle nut. The transmission element 101 has an internal thread 102 and an external toothing. The internal thread 102 is in engagement with the transmission element 101 via the spindle 12. The external toothing engages with another transmission element 103 in the form of a worm. The further transmission element 103 is oriented parallel to the motor axis of rotation M. The further transmission element 103 can be driven by the electric motor 113 and drives the transmission element 101 in the form of the spindle nut so that it is screwed along the spindle 12. The transmission elements 101, 103 are mounted in the transmission housing 109 and arranged with the transmission housing 109 in the transmission holder 100.

### LIST OF REFERENCE NUMBERS

1 drive device
10 transmission
100 transmission holder
101 transmission element (spindle nut)
102 internal thread
103 transmission element (worm)
104 counter stop
105 bearing cover
106 portion
107 cage
108 bearing point
109 transmission housing
11 motor unit
110 motor housing
111 predetermined breaking element
112 stop
113 electric motor
12 spindle
120 bearing point
13, 14 bearing element
2 vehicle seat
20 seat part
200 seat mat
201 cross tube
202 side part
21 backrest
22 fitting arrangement
23 height adjustment device
230 lever
24 longitudinal adjustment device
240 seat rail
AP deflected position
B base
BP operating position
D axis of rotation
F force
FB vehicle floor
G sliding surface
L bearing portion
M motor axis of rotation
S pivot axis

1. A drive device for adjusting a vehicle seat, comprising:
a transmission with a transmission holder and
a motor unit with a motor housing which is arranged on the transmission holder and is held in an operating position (BP) relative to the transmission holder by means of a predetermined breaking element,
wherein the motor housing can be moved from the operating position (BP) into a deflected position (AP) relative to the transmission holder by the destruction of the predetermined breaking element.

2. The drive device according to claim 1, wherein the motor housing can be pivoted from the operating position (BP) into the deflected position (AP) relative to the transmission holder by the destruction of the predetermined breaking element.

3. The drive device according to claim 2, wherein the motor housing can be pivoted from the operating position (BP) into the deflected position (AP) about an axis of rotation (D) of a transmission element of the transmission relative to the transmission holder.

4. The drive device according to claim 3, wherein the transmission element has an internal thread.

5. The drive device according to claim 3, wherein the transmission element is in engagement with a spindle.

6. The drive device according to claim 1, wherein the predetermined breaking element can be sheared off in order to allow a movement of the motor housing from the operating position (BP) into the deflected position (AP) relative to the transmission holder.

7. The drive device according to claim 6, wherein the predetermined breaking element is designed in the form of a shear-off lug.

8. The drive device according to claim 1, wherein the motor housing and/or a transmission housing fixed to the motor housing forms the predetermined breaking element.

9. The drive device according to claim 1, wherein a stop is provided which is fixed to the motor housing and is designed to strike a counter stop of the transmission holder in the deflected position.

10. The drive device according to claim 1, wherein the motor housing is made of plastic.

11. The drive device according to claim 1, wherein the motor unit comprises an electric motor.

12. The drive device according to claim 1, wherein the drive device is adjustable both when the motor housing is arranged in the operating position (BP) and when it is arranged in the deflected position (AP).

13. A vehicle seat, wherein the drive device according to claim 1.

14. The vehicle seat according to claim 13, wherein the drive device is designed to adjust a seat height of a seat part of the vehicle seat relative to a base (B) of the vehicle seat.

15. The vehicle seat according to claim 14, wherein the seat part is supported on the base (B) via a lever, wherein the drive device is designed to exert a force on the lever and/or on the seat part.

16. The vehicle seat according to claim 13, wherein the motor unit is arranged under a seat mat of the vehicle seat and is designed to support a seat cushion.

17. The vehicle seat according to claim 14, wherein the motor unit is arranged under a seat mat of the vehicle seat and is designed to support a seat cushion.

18. The vehicle seat according to claim 15, wherein the motor unit is arranged under a seat mat of the vehicle seat and is designed to support a seat cushion.
